(19) United States
(12) Patent Application Publication
(10) Pub. No.: US 2004/0265056 A1
(43) Pub. Date: Dec. 30, 2004

(54) Road stud

(76) Inventors: Dong-hwan Kim, Seoul City (KR); Seung-hyun Yang, Seoul City (KR); Hyung-ju Na, Seoul City (KR)

Correspondence Address: CANTOR COLBURN, LLP, 55 GRIFFIN ROAD SOUTH, BLOOMFIELD, CT, 06002

(21) Appl. No.: 10/485,666

(22) PCT Filed: Aug. 1, 2002
(86) PCT No.: PCT/KR02/01457

(30) Foreign Application Priority Data
Aug. 3, 2001 (KR) 2001-0047014
Aug. 9, 2001 (KR) 2001-0048064

(51) Int. Cl. G08B 1/00

(52) U.S. Cl. 404/16

(57) ABSTRACT

Disclosed is a road stud comprising an indicating part 10 exposed on a road surface 5, an anchor 20 extended from the bottom of the indicating part 10 and inserted into an anchor inserting hole 7 provided under the road surface 5; and a rotation preventing projection 33 radially protruded form a central axis of the anchor 20 and preventing the indicating part 10 form being rotated. With this configuration, the present invention provides a road stud which is prevented from being rotated at random by external force after installation. Further, the present invention provides a road stud which is conveniently and quickly installed. Further, the present invention provides a road stud which is recyclable and environmental-friendly because the road stud is installed without glue such as epoxy resin containing carcinogen. Further, the present invention provides a road stud which is installed anytime regardless of restriction conditions such as the relative humidity of air and the dryness of a road surface.

### FIELD OF THE INVENTION

The present invention relates to a road stud.

### BACKGROUND ART

A road stud is generally installed along a central line of a pavement at regular intervals so as to allow a driver to effectively watch the central line of the pavement. The road stud comprises an indicating part provided with a reflector reflecting light, and an anchor extended from the bottom of the indicating part and inserted under a road surface, and is manufactured meeting predetermined standards.

Hereinbelow, the installation of the conventional road stud will be described. First, an anchor inserting hole is dug after determining a position where the road stud is studded. Herein, the depth of the anchor inserting hole is lager than the length of the anchor of the road stud. Then, glue is poured into the anchor inserting hole fully after removing extraneous substance such as dust, oil, etc. on the road surface.

Thereafter, the anchor of the road stud is inserted into the anchor inserting hole, and then the indicating part of the road stud is given vibration, thereby applying the glue to the anchor thoroughly. Thereafter, the road stud is stayed as it is until the glue is dried up completely, and then the glue exposed to the road surface is removed, thereby finishing the installation of the conventional road stud.

However, because the conventional road stud is fixed into the pavement by only adhesive strength of the glue, and external force such as a shock of a car decreases the adhesive strength of the glue, the indicating part may be rotated on the road surface according as the cars hit the road stud.

Thus, according as the indicating part is rotated, the reflective angle of the reflector is changed, and therefore the road stud cannot use its function to indicate the central line of the pavement to the full. Further, the frequent rotation causes the road stud to be separated from the anchor inserting hole, and the breakaway road stud can cause accidents.

### DISCLOSURE OF INVENTION

Accordingly, the present invention has been made keeping in mind the above-described shortcoming and user's need, and an object of the present invention is to provide a road stud which is prevented from being rotated at random by external force after installation.

Another object of the present invention is to provide a road stud which is conveniently and quickly installed.

Another object of the present invention is to provide a road stud which is recyclable and environmental-friendly because the road stud is installed without glue such as epoxy resin containing carcinogen.

Another object of the present invention is to provide a road stud which is installed anytime regardless of restriction conditions such as the relative humidity of air and the dryness of a road surface.

This and other objects of the present invention may be accomplished by the provision of a road stud comprising an indicating part exposed on a road surface; an anchor extended from the bottom of the indicating part and inserted into an anchor inserting hole provided under the road surface; and a rotation preventing projection radially protruded from a central axis of the anchor and preventing the indicating part from being rotated.

Preferably, the road stud further comprises a reinforcing plate formed with an anchor through hole through which the anchor is fitted, and the rotation preventing projection is provided on the reinforcing plate.

Preferably, the rotation preventing projection is formed by cutting and bending a part of the reinforcing plate.

Preferably, the rotation preventing projection has a round edge.

Preferably, the anchor through hole is formed with a predetermined cut-off lines.

Preferably, the reinforcing plate is combined to the bottom of the indicating part by welding.

Preferably, the rotation preventing projection is provided in the indicating part.

Preferably, the road stud further comprises a locking member combined to the anchor, having a holding projection radially provided to the central axis of the anchor and elastically contacting and supporting the inside wall of the anchor inserting hole so as to prevent the anchor from breaking away from the anchor inserting hole.

Preferably, the locking member includes a combination part to be combined to the anchor, and a plurality of elastic holding parts extended from the combination part, being arranged around the anchor, and elastically holding the anchor in the anchor inserting hole.

Preferably, the holding projection is formed on a free end of the elastic holding part.

Preferably, at least one of the elastic holding parts is formed in a pair.

Preferably, the combination part of the locking member includes a hole to which the anchor is fitted.

Preferably, on the hole is formed with a cut-off line with a predetermined length

Preferably, the road stud further comprises a breakaway preventing washer having a through hole to which the anchor is inserted, and combined to the outside of the locking member fitted to the anchor in order to prevent the locking member from breaking away from the anchor.

Preferably, the road stud further comprises a sink-preventing projection provided in the locking member and preventing the anchor inserted in the anchor inserting hole from sinking down.

Preferably, the anchor is formed with a stepped end part.

Preferably, the rotation preventing projection is provided in the elastic holding part.

Preferably, the rotation preventing projections are extended from the opposite edges of the elastic holding part, transversely to a lengthwise direction of the elastic holding part.

### BRIEF DESCRIPTION OF DRAWINGS

The present invention will be better understood and its various objects and advantages will be more fully appreciated from the following description taken in conjunction with the accompanying drawings, in which:

FIG. 1 is an exploded perspective view of a road stud and a reinforcing plate according to a first embodiment of the present invention;

FIG. 2 is a rear perspective view of FIG. 1;

FIG. 3 is a perspective view illustrating the combination of the road stud and the reinforcing plate of FIG. 2;

FIG. 4 is a sectional view of the road stud installed on the road surface according to the first embodiment of the present invention;

FIG. 5 is a rear exploded perspective view of a road stud and a reinforcing plate according to a second embodiment of the present invention;

FIG. 6 is a perspective view illustrating the combination of the road stud and the reinforcing plate of FIG. 5;

FIG. 7 is a sectional view of the road stud installed on the road surface according to the second embodiment of the present invention;

FIG. 8 is a rear perspective view of a road stud according to a third embodiment of the present invention;

FIG. 9 is a rear perspective view of a road stud according to a fourth embodiment of the present invention;

FIG. 10 is a perspective view of a road stud according to a fifth embodiment of the present invention;

FIG. 11 is a rear perspective view of FIG. 10;

FIG. 12 is an exploded perspective view of FIG. 11;

FIGS. 13 through 15 illustrate the installation of the road stud according to the fifth embodiment of the present invention in sequence;

FIG. 16 is a sectional view of a road stud installed on the road surface according to a sixth embodiment of the present invention;

FIG. 17 is a sectional view of a road stud installed on the road surface according to a seventh embodiment of the present invention;

FIG. 18 is a rear exploded perspective view of a road stud according to an eighth embodiment of the present invention;

FIG. 19 is a rear exploded perspective view of a road stud according to a ninth embodiment of the present invention;

FIG. 20 is a rear exploded perspective view of a road stud according to a tenth embodiment of the present invention;

FIG. 21 is a rear exploded perspective view of a road stud according to an eleventh embodiment of the present invention;

FIG. 22 is a perspective view of a road stud according to a twelfth embodiment of the present invention;

FIG. 23 is a rear perspective view of FIG. 22;

FIG. 24 is an exploded perspective view of FIG. 23; and

FIG. 25 is a sectional view of a road stud installed on the road surface according to the twelfth embodiment of the present invention.

### MODES FOR CARRYING OUT THE INVENTION

Hereinafter, a first embodiment of preferred embodiments will be described as a representative of the present invention in more detail with reference to the accompanying drawings, and the other embodiments will be described in only respects different from the first embodiment, wherein like reference numerals refer to the like elements throughout.

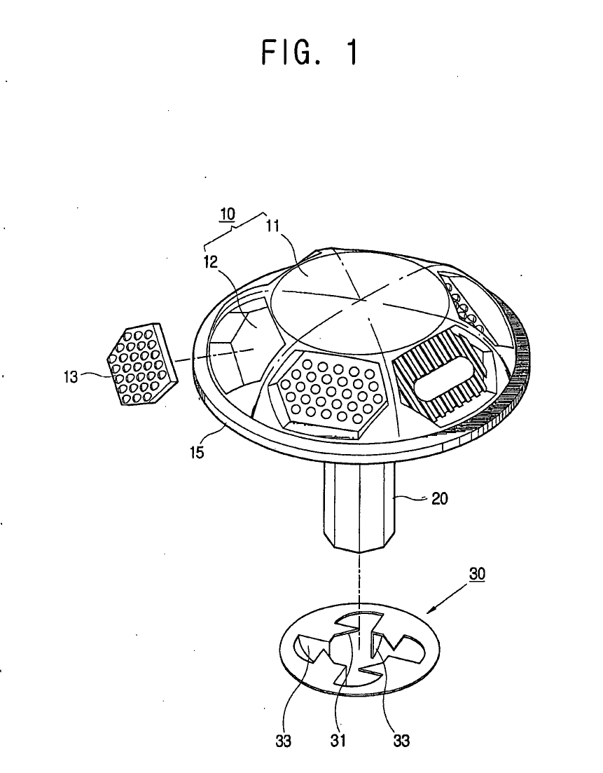

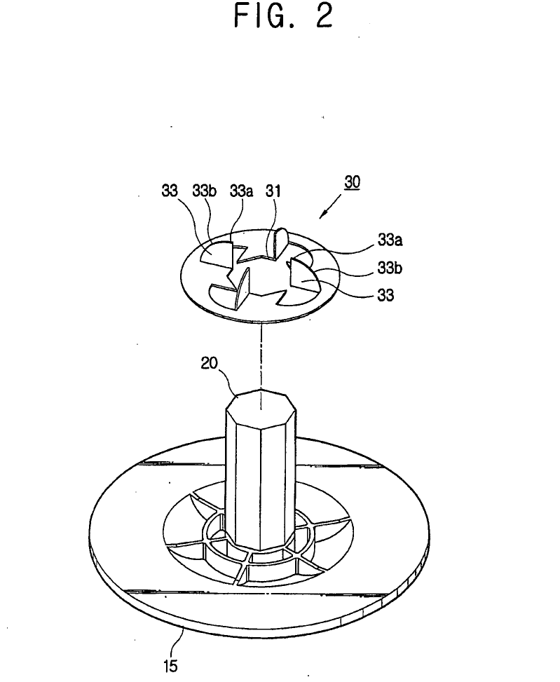

As shown in FIGS. 1 through 3, a road stud according to a first embodiment of the present invention comprises an indicating part 10 exposed on a road surface 5 and indicating a lane, and an anchor 20 extended from the bottom of the indicating part 10 and inserted into an anchor inserting hole 7 provided under the road surface 5.

The indicating part 10 is of a truncated cone shape and includes a contact surface 9 to come in contact with the road surface 5. On the upper face of the indicating part 10 is provided a design carving part 11 in which a design for publicity is carved, and around the design carving part 11 is provided a plurality of reflector grooves 12. To the reflector groove 12 is combined a reflector 13 reflecting light diffusely.

In the present embodiment, because the indicating part 10 is of a truncated cone shape, a car is protected from a breakage in a tire even if the car passes thereon. However, the indicating part 10 may have a truncated quadrangular shape. Further, the bottom of the indicating part 10 may be partially grooved enough to hide a reinforcing plate 30 (to be described later), so the thickness of the reinforcing plate 30 does not affect close contact of a skirt part 15 (to be described later) and the road surface 5 though the reinforcing plate 30 is combined to the bottom of the indicating part 10.

Between the indicating part 10 and the anchor 10 is provided the skirt part 15 extended radially in parallel with the road surface 5. The skirt part 15 is in close contact with the road surface 5, to thereby provide a smooth connection between the indicating part 10 and the road surface 5.

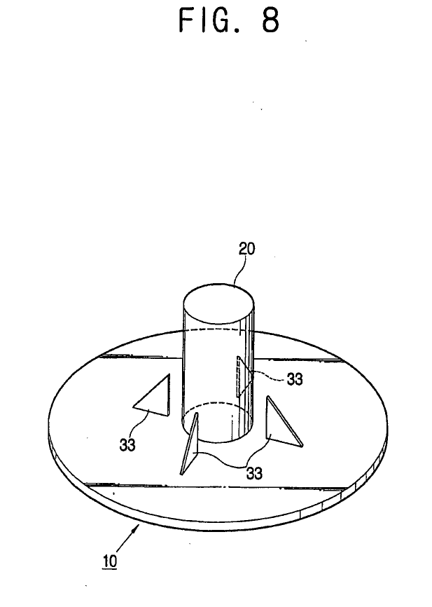

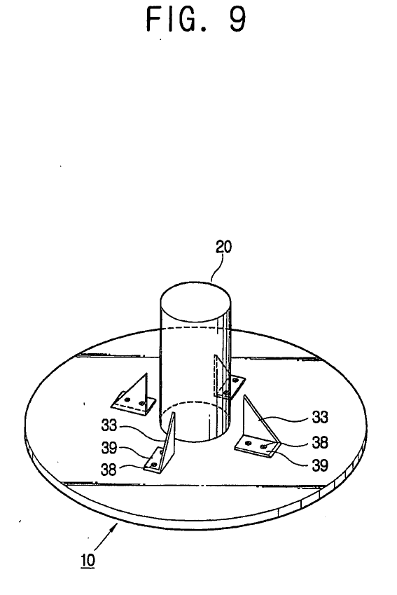

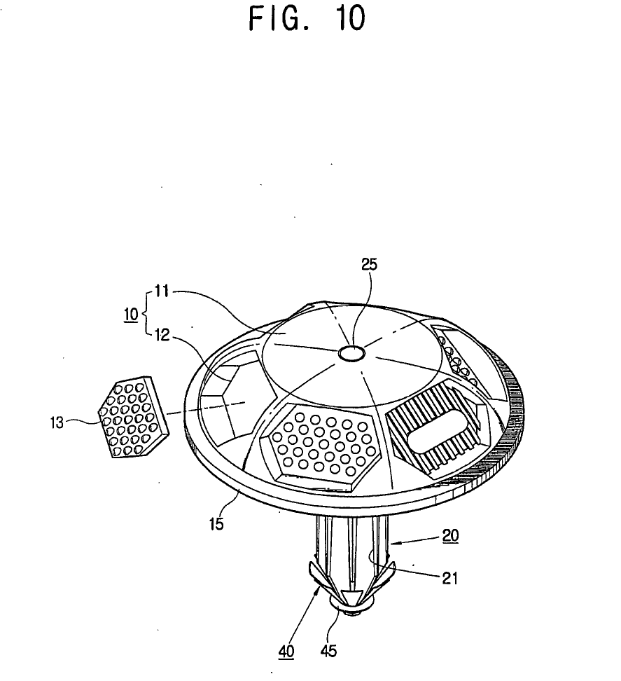

The anchor 20 has a noncircular cross section in order to be fitted to an anchor through hole 31 of the reinforcing plate 30, but may has a cylindrical shape (refer to FIGS. 8 and 9). Further, the anchor 20 may have a noncircular cross-section formed with a groove 21 at every side along a lengthwise direction thereof (refer to FIG. 10). Herein, the anchor 20 and the indicating part 10 may be formed as a single body, or may be separately formed and combined by a bolt, welding, or etc.

The reinforcing plate 30 is fitted to the anchor 20 so as to prevent the indicating part 10 from being rotated. On the reinforcing plate 30 is provided the anchor through hole 31 through which the anchor 20 is passed. The anchor through hole 31 is shaped in correspondence with the cross section of the anchor 20, thereby allowing the reinforcing plate 30 to be fitted to the anchor 20.

Thus, when the reinforcing plate 30 is fitted to the anchor 20 through the anchor through hole 31, the reinforcing plate 30 does not rotate about the anchor 20. Additionally, the anchor through hole 31 may be formed with predetermined cut-off lines (not shown) so as to assist the reinforcing plate 30 in being easily fitted to the anchor 20.

The reinforcing plate 30 to be disposed on the contact surface 9 is formed with a plurality of rotation preventing projections protruded transversely from the surface of the reinforcing plate 30 and studded in the road surface 5, thereby preventing the indicating part 10 from being rotated.

Herein, the rotation preventing projection 33 may be formed separately and combined to the reinforcing plate 30. However, according to the present embodiment, the rotation preventing projection 33 is formed by cutting partially and bending perpendicularly the inside of the reinforcing plate 30. The rotation preventing projection 33 has a sharp point 33a and a round edge 33b so as to be easily studded in the road surface 5.

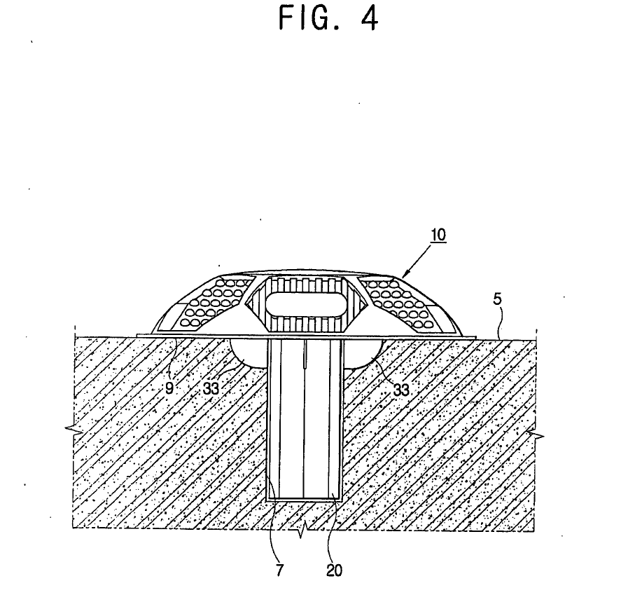

With this configuration, the process of installing the road stud according to the present invention will be described hereinbelow referring to FIG. 4.

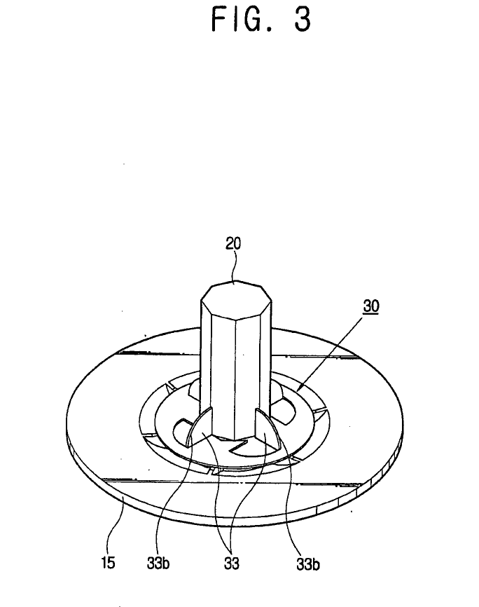

First, the reinforcing plate 30 is fitted to the anchor 20 through the anchor through hole 31 until the reinforcing plate 30 is placed on the bottom of the indicating part 10. Herein, the rotation preventing projections 33 formed in the reinforcing plate 30 are perpendicular to the contact surface 9 of the indicating part 10. Additionally, in order to combine the reinforcing plate 30 with the anchor 20 firmly, the reinforcing plate 30 may be rotated at a predetermined angle after being fitted to the anchor 20 (refer to FIG. 3).

Thereafter, a position where the road stud is installed is determined, and the anchor inserting hole 7 is dug at the determined position, and then extraneous substance such as dust, oil, etc. on the road surface 5 is removed.

Thereafter, glue is poured into the anchor inserting hole 7 fully, and then the anchor 20 of the road stud is inserted in the anchor inserting hole 7. When the indicating part 10 is downward pressed in order to insert the anchor 20 in the anchor inserting hole 7, the rotation preventing projections 33 formed in the reinforcing plate 30 are studded in the road surface 5. Therefore, after finishing the installation of the road stud, the road stud cannot rotate because of the rotation preventing projections 33.

Thereafter, the indicating part 10 of the road stud is given vibration so as to apply the glue to the anchor thoroughly, and then the road stud is stayed as it is until the glue is completely dried up. After drying up the glue completely, the glue exposed to the road surface 5 is removed, thereby finishing the installation of the conventional road stud.

As described above, the present invention provides the rotation preventing projection 33 protruded transversely from the contact surface 9 of the indicating part 10 and studded in the road surface 5, so the rood stud is prevented from being rotated by external force.

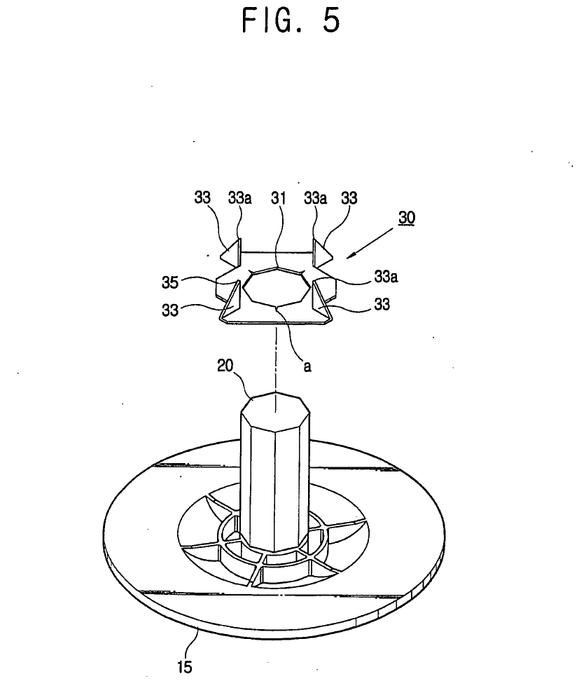

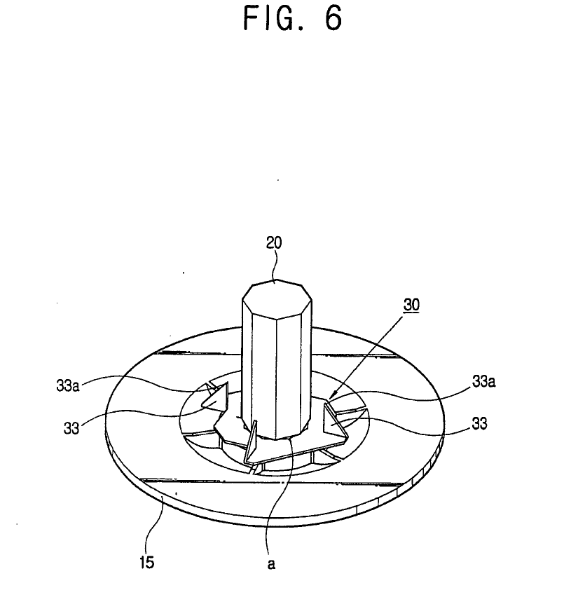

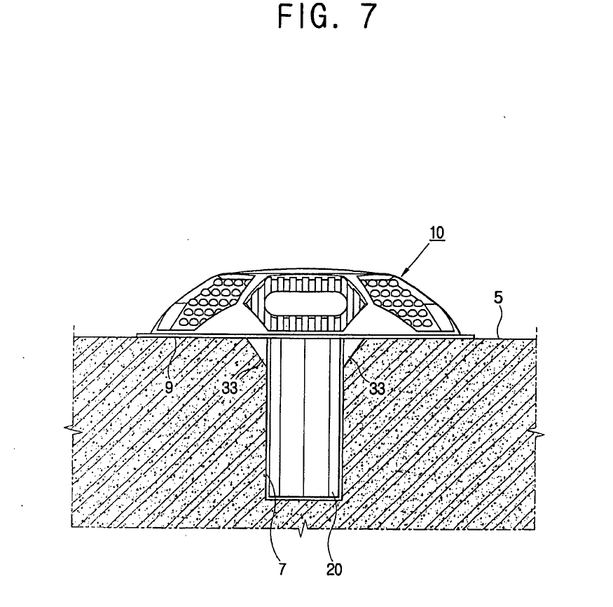

On the other hand, as shown FIGS. 5 through 7, a reinforcing plate 30 can be formed as follows according to a second embodiment of the present invention. That is, rotation preventing projections 33 are each formed by cutting the edges of the reinforcing plate 30 having a rectangular shape and bending the cut part perpendicularly, and an anchor through hole 31 is formed on the center of the reinforcing plate 30 independently of the rotation preventing projections 33 contrary to the first embodiment. Further, the anchor through hole 31 is formed with a cut-off line “a” so as to assist the reinforcing plate 30 in being easily fitted to the anchor 20. Further, the rotation preventing projection 33 has a sharp point 33a sharper than that of the first embodiment, so it is more easily studded in the road surface 5. Herein, the other elements and the installation of the reinforcing plate 30 according to the second embodiment are equal to those of the first embodiment, and therefore the repetitive descriptions were avoided.

In the first and second embodiments, the reinforcing plate 30 formed with the plurality of rotation preventing projections 33 is separately provided and combined to the indicating part 10. However, as shown in FIGS. 8 and 9, a rotation preventing projection 33 can be directly provided in an indicating part 10 according to third and forth embodiments of the present invention. In this case, the bottom of the indicating part 10 is flat.

FIG. 8 illustrates the rotation preventing projection 33 formed on the indicating part 10 as a single body, or welded to the indicating part 10. However, if the rotation preventing projection 33 is different from the indicating part 10 in material, it is difficult to weld the rotation preventing projection 33 to the indicating part 10. In this case, as shown in FIG. 9, the rotation preventing projection 33 includes a flange part 39, and the flange part 39 and the indicating part 10 are combined each other by means of a screw 38, a rivet (not shown), or etc., so that the rotation preventing projection 33 is formed on the indicating part 10.

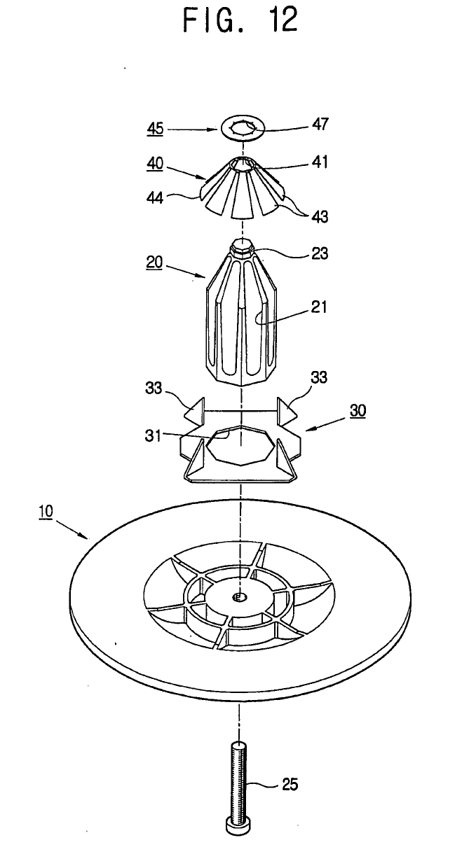

On the other hand, FIGS. 10 through 12 illustrate a road stud according to a fifth embodiment of the present invention. According to the fifth embodiment, an anchor 20 is provided with a locking member 40 having a hole 41, and a breakaway preventing washer 45 having through hole 47. Further, the anchor 20 has a noncircular cross section in order to be fitted to an anchor through hole 31 of the reinforcing plate 30, i.e., is of an octahedral column shape, which has a groove 21 at every side along a lengthwise direction thereof. Herein, the anchor 20 is combined to an indicating part 10 by means of a bolt 25.

The anchor 20 is formed with a stepped end part 23. In the present embodiment, the stepped end part 23 is employed in fitting the hole 41 and the through hole 47 thereto. If the anchor 20 is not formed with the stepped end part, the hole 41 and the through hole 47 are fitted to the anchor 20 after widening the size thereof. Further, the stepped end part 23 may have various shapes.

The locking member 40 comprises a combination part to be combined to the stepped end part 23 of the anchor 20, and a plurality of elastic holding parts 43 extended from the combination part, surrounding the anchor 20, and elastically holding the anchor 20 in the anchor inserting hole 7.

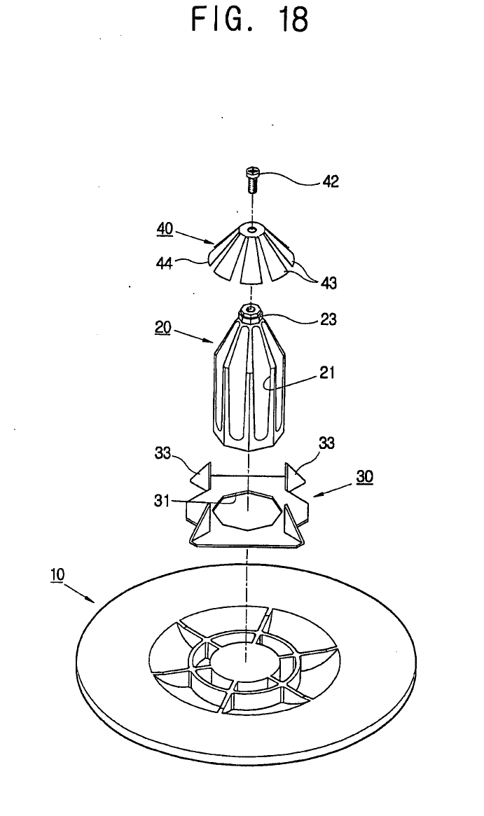

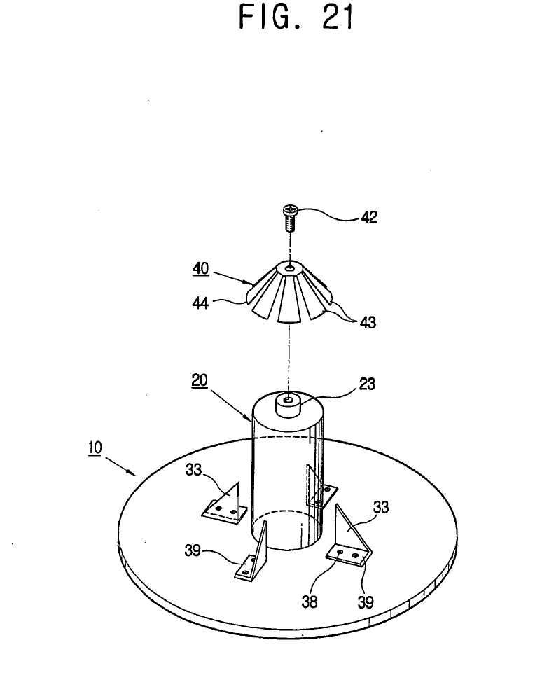

The combination part includes the hole 41 having a shape corresponding to the stepped end part 23 of the anchor 20, and fitted to the stepped end part 23. Herein, it is preferable that the hole 41 has cut-off lines (not shown) with a predetermined length. Thus, when the stepped end part 23 of the anchor 20 is forcibly inserted in the hole 41, the cut-off lines become open, thereby allowing the anchor 20 to be easily fitted. After the anchor 20 is completely inserted, the cut-off lines are closed to become in contact with a side of the anchor 20, thereby preventing the locking member 40 from breaking away from the stepped end part 23 of the anchor 20. However, the combination part may comprise a bolt 42 (refer to FIGS. 18 and 21) besides the hole 41. Further, the locking member 40 may be combined to the anchor 20 by welding.

The plurality of elastic holding parts 43 is arranged around the anchor 20 and elastically holds the anchor 20 in the anchor inserting hole 7.

Thus, when the anchor 20 is inserted into the anchor inserting hole 7, the free ends of the elastic holding parts are elastically deformed toward the anchor 20, and then, when the anchor 20 is completely inserted into the anchor inserting hole 7, elastically contacting and supporting the inside wall of the anchor inserting hole 7.

It is preferable that the elastic holding part 43 has a curved surface in correspondence with the side shape of the anchor 20. Further, each free end of the elastic holding parts 43 is employed as a holding projection 44 which is held by the inside wall of the anchor inserting hole 7 against a breakaway direction of the anchor 20.

To the stepped end part 23 of the anchor 20 is fitted the breakaway preventing washer 45 having the thorough hole 47. The breakaway preventing washer 45 is combined to the outside of the locking member 40 fitted to the anchor 20, and prevents the locking member 40 from breaking away from the stepped end part 23 of the anchor 20. Herein, it is preferable that the through hole 47 is formed with cut-off lines (not shown) allowing the through hole 47 to be easily fitted.

Further, to the anchor 20 is combined a reinforcing plate 30 preventing an indicating part 10 from being rotated at random by external force after being installed on the road surface 5. On the reinforcing plate 30 is formed an anchor through hole 31 through which the anchor 20 is passed. The anchor through hole 31 is shaped in correspondence with the cross section of the anchor 20, thereby allowing the reinforcing plate 30 to be fitted to the anchor 20.

Thus, when the reinforcing plate 30 is fitted to the anchor 20 through the anchor through hole 31, the reinforcing plate 30 does not rotate about the anchor 20. Additionally, the anchor through hole 31 may be formed with predetermined cut-off lines (not shown) so as to assist the reinforcing plate 30 in being easily fitted to the anchor 20.

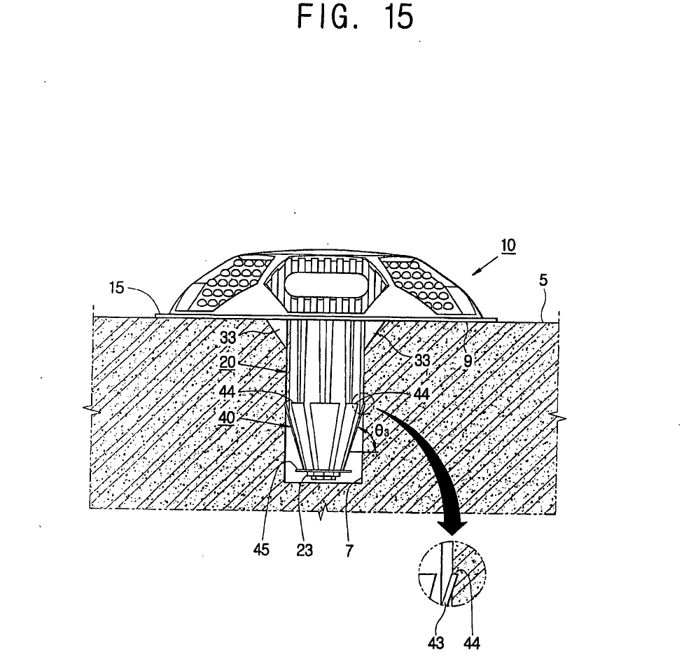

The reinforcing plate 30 to be disposed on the contact surface 9 (refer to FIG. 15) is formed with a plurality of rotation preventing projections protruded transversely from the surface of the reinforcing plate 30 and studded in the road surface 5, thereby preventing the indicating part 10 from being rotated.

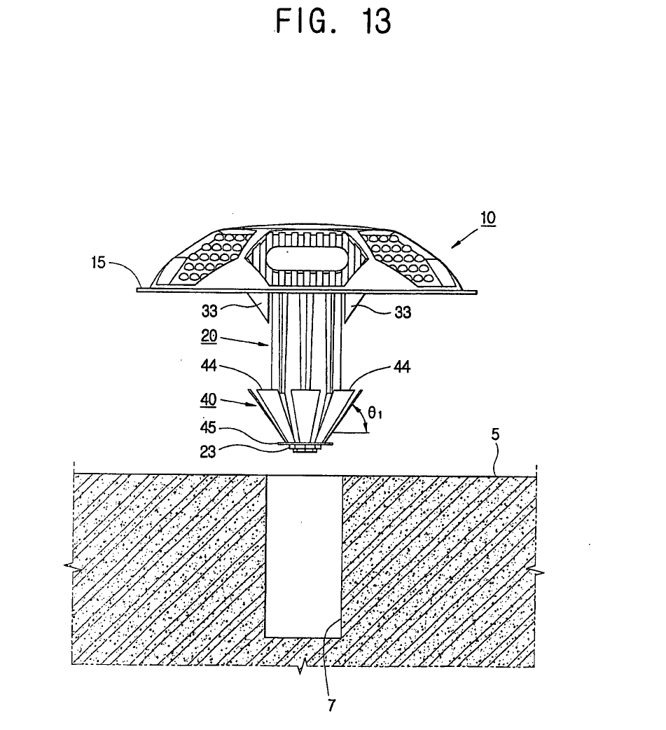

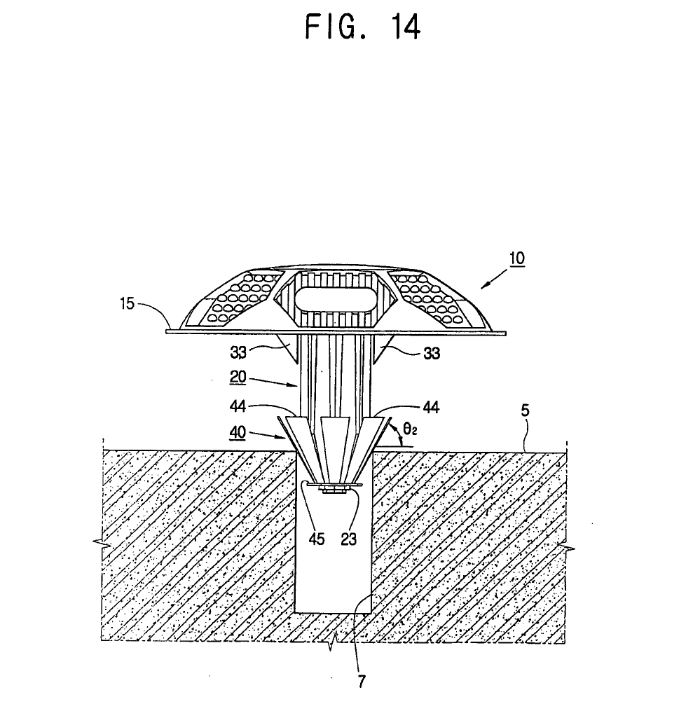

With this configuration, the process of installing the road stud equipped with the reinforcing plate 30 and the locking member 40 in the road surface 5 will be described hereinbelow, referring to FIGS. 13 through 15.

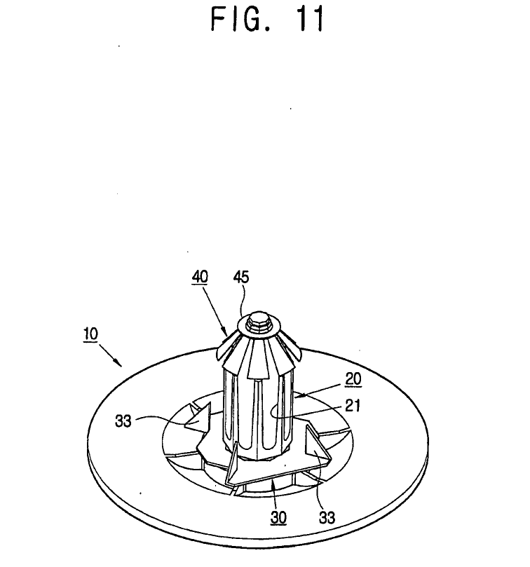

First, the reinforcing plate 30 is fitted to the anchor 20 through the anchor through hole 31 until the reinforcing plate 30 is placed on the bottom of the indicating part 10. Herein, the rotation preventing projections 33 formed in the reinforcing plate 30 are perpendicular to the contact surface 9 of the indicating part 10. Additionally, in order to combine the reinforcing plate 30 with the anchor 20 firmly, the reinforcing plate 30 may be rotated at a predetermined angle after being fitted to the anchor 20 (refer to FIG. 11).

Thereafter, the locking member 40 is fitted to the stepped end part 23 of the anchor 20 through the hole 41. At this time, the cut-off lines formed in the hole 41 become open, so the stepped end part 23 of the anchor 20 is easily fitted to the hole 41 of the locking member 40. After the anchor 20 is completely inserted, the cut-off lines are elastically closed to become in contact with a side of the stepped end part 23, thereby preventing the locking member 40 from breaking away from the anchor 20. Thereafter, the breakaway preventing washer 45 is combined to the stepped end part 23 of the anchor 20 at the outside of the locking member 40, thereby supplementarily preventing the locking member 40 from breaking away from the stepped end part 23 of the anchor 20.

Thereafter, a position where the road stud is installed is determined, and the anchor inserting hole 7 is dug at the determined position. Herein, contrary to the first through fourth embodiments, in the present embodiment, there is no necessity for removing extraneous substance such as dust, oil, etc. on the road surface 5 because the road stud is installed without glue. Therefore, the road stud according to the present embodiment is conveniently and quickly installed.

Thereafter, the anchor 20 is forcibly inserted into the anchor inserting hole 7. At this time, the holding projections 44 of the elastic holding parts 43 are elastically deformed toward the anchor 20 (Θ₁˜Θ₃). After the anchor 20 is completely inserted into the anchor inserting hole 7, the holding projections 44 of the elastic holding part 43 elastically contacts and supports the inside wall of the anchor inserting hole 7, thereby preventing the anchor 20 breaking way from the anchor inserting hole 7.

When the indicating part 10 is downward pressed in order to insert the anchor 20 in the anchor inserting hole 7, the rotation preventing projections 33 formed in the reinforcing plate 30 are studded in the road surface 5. Therefore, after finishing the installation of the road stud, the road stud is prevented from being rotated at random by external force.

Herein, the drawings according to the present embodiment illustrate that only the holding projections 44 of the elastic holding part 43 are partially studded in the inside wall of the anchor inserting hole 7, so the space between the elastic holding part 43 and the inside wall of the anchor inserting hole 7 seems to be relatively wide, i.e., it is exaggerated in order to give better understanding of description. However, practically, there is little space between the elastic holding part 43 and the inside wall of the anchor inserting hole 7.

On the other hand, removal of the road stud is accomplished by lifting up the road stud from the road surface 5 enough to go beyond elastic limits of the elastic holding part 43. At this time, the holding projections 44 are downwardly bent.

As described above, the road stud according to the present invention is conveniently and quickly installed. Further, a road stud is environmental-friendly because the road is stud installed without glue such as epoxy resin containing carcinogen.

Moreover, a road stud 20 is installed anytime regardless of restriction conditions such as the relative humidity of air and the dryness of a road surface, and is prevented from random rotation due to external force after the installation.

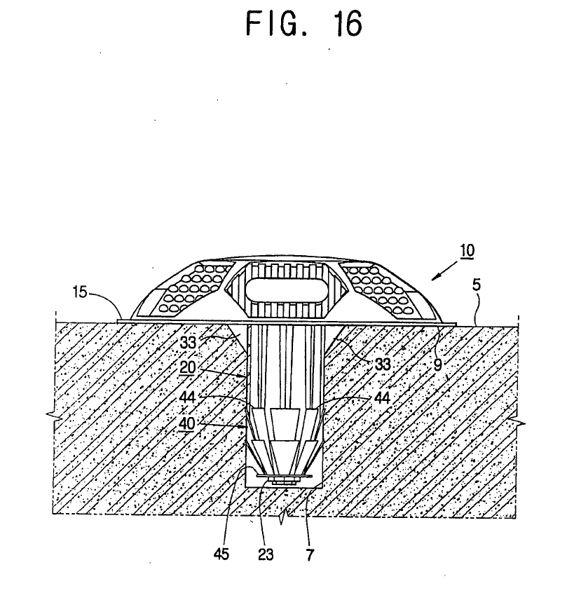

Further, as shown in FIG. 16, a sixth embodiment of the present invention provides a pair of locking members 40 each having a holding projection 44.

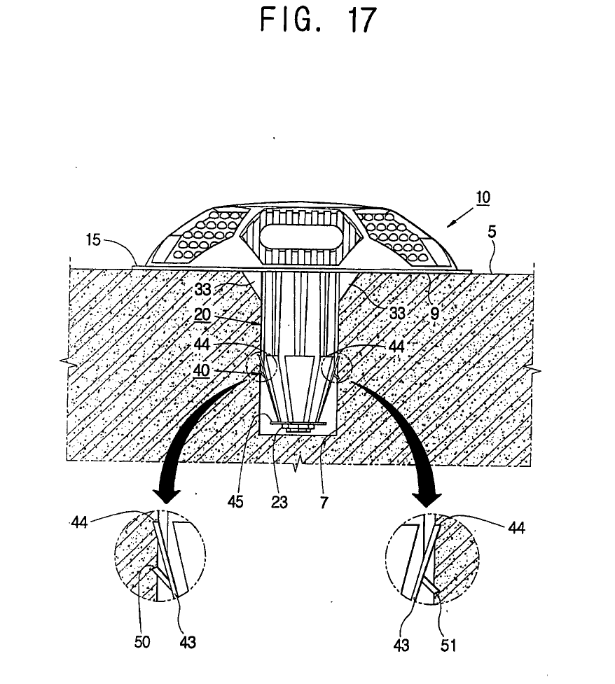

Further, as shown in FIG. 17, a seventh embodiment of the present invention provides a subsidiary holding-projection 50 formed by partially cutting and bending a surface of an elastic holding part 43, to thereby better the present invention. Herein, at least one of the subsidiary holding-projections 50 may have a slant opposite to those of the other subsidiary holding-projections 50, and employed as a sink-preventing projection 51 so as to prevent the anchor 20 inserted in the anchor inserting hole 7 from sinking down.

Further, as shown in FIG. 18, according to an eight embodiment of the present invention, the road stud having a locking member 40 employs a bolt 42 as a combination part thereof, thereby being combined to an anchor 20 by means of the bolt 42.

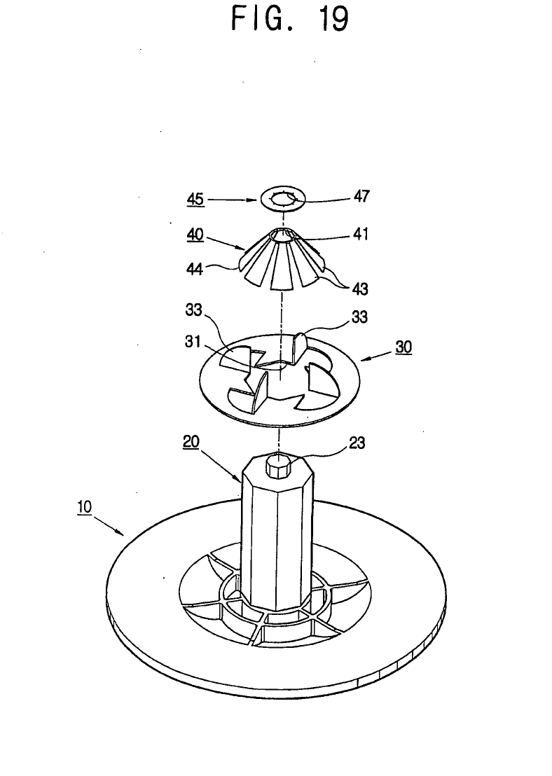

Further, as shown in FIG. 19, according to a ninth embodiment of the present invention, the road stud having a locking member 40 comprises an anchor 20 having a noncircular cross section different from that of the above-described embodiment.

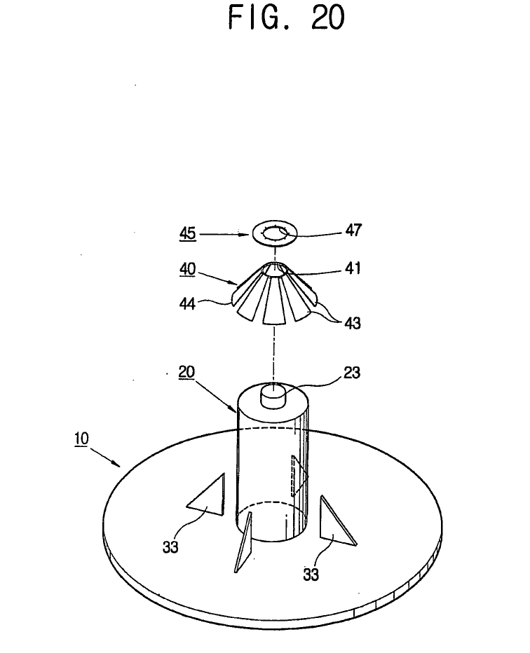

In the fifth through ninth embodiments, the road stud having the locking member 40 is separately provided with the reinforcing plate 30 including the rotation preventing projections 33. However, as shown in FIG. 20, according to a tenth embodiment of the present invention, a rotation preventing projection 33 may be directly formed on the bottom of an indicating part 10.

Further, if the rotation preventing projection 33 is different from the indicating part 10 in material, it is difficult to weld the rotation preventing projection 33 to the indicating part 10. In this case, according to an eleventh embodiment of the present invention, a rotation preventing projection 33, as shown in FIG. 21, includes a flange part 39, and the flange part 39 and the indicating part 10 are combined each other by means of a screw 38, a rivet (not shown), or etc., so that the rotation preventing projection 33 is directly formed on the indicating part 10.

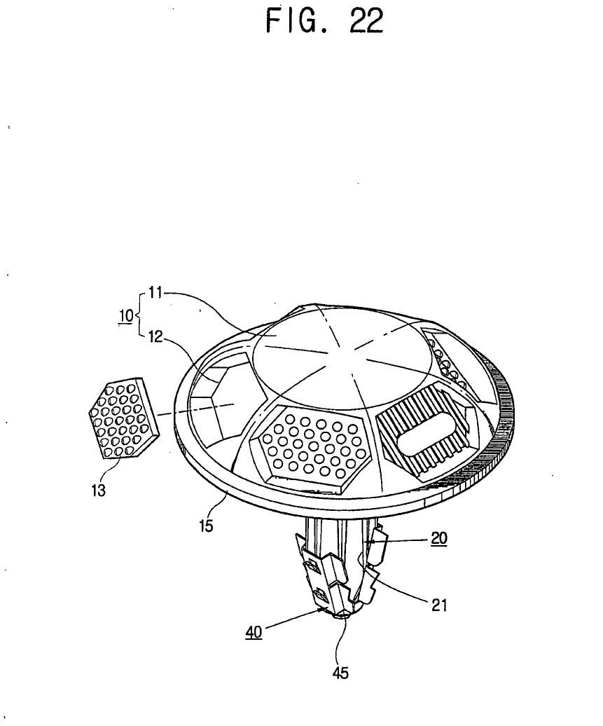

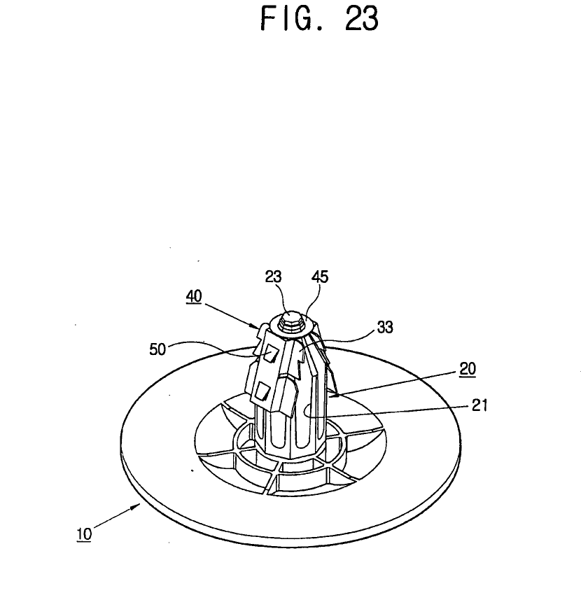

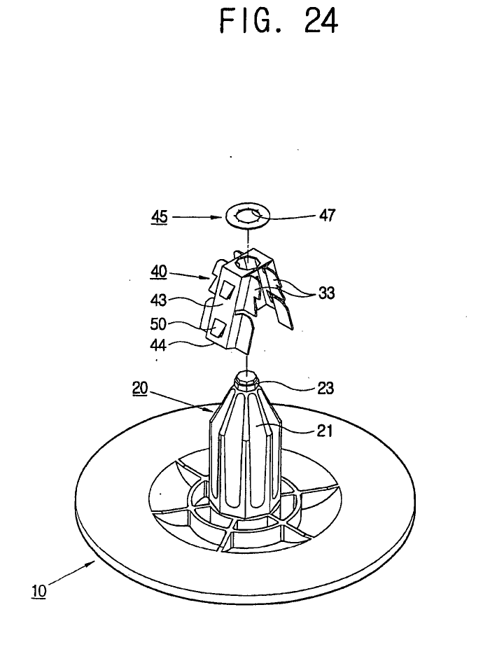

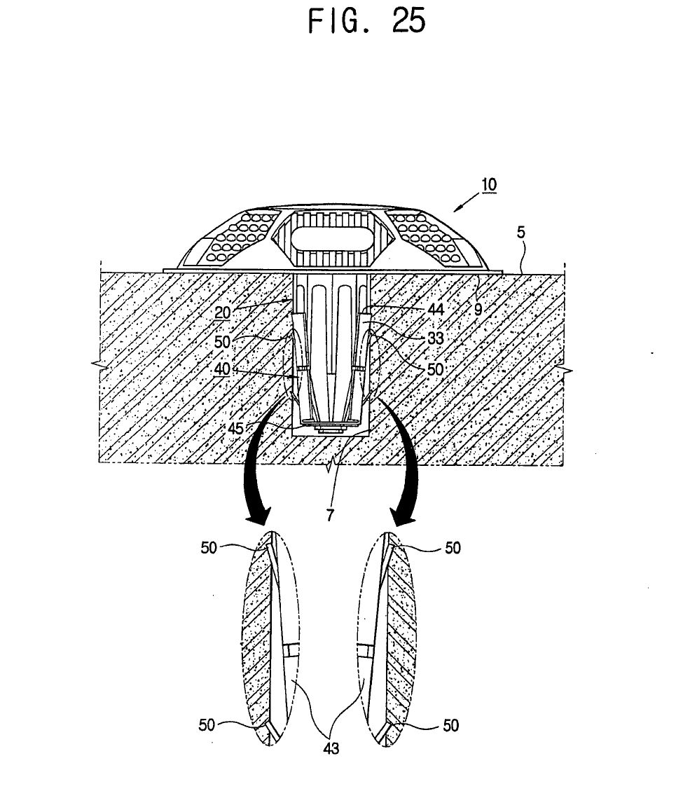

Further, as shown in FIGS. 22 through 25, according to a twelfth embodiment of the present invention, an anchor 20 has a noncircular cross-section formed with a groove 21 at every side, and a locking member 40 includes a pair of elastic holding parts 43 facing each other across the anchor 20. Rotation preventing projections 33 are extended from the opposite edges of the elastic holding part 43, transversely to a lengthwise direction of the elastic holding part 43. The rotation preventing projections 33 has a barb shape, and therefore are easily studded in the inside wall of an anchor inserting hole 7. Further, the elastic holding part 43 includes subsidiary holding-projections 50 thereon. Thus, the rotation preventing projections 33 are provided in the opposite edges of the elastic holding part 43 instead of the reinforcing plate 30 or the bottom of the indicating part 10, and the subsidiary holding-projections are provided on the elastic holding part 43, thereby preventing not only the indicating part 10 from being rotated at random by external force but also the anchor 20 from breaking away from an anchor inserting hole 7. Herein, the anchor 20 may have a noncircular cross-section without the groove 21 or a circular cross-section, selectively.

In the above embodiments, the present invention is applied to the road stud having the indicating part provided with a reflector. However, the present invention may be applied to a road stud having an indicating part provided with a luminous means.

As described above, the present invention provides a road stud which is prevented from being rotated at random by external force after installation.

Further, the present invention provides a road stud which is conveniently and quickly installed.

Further, the present invention provides a road stud which is recyclable and environmental-friendly because the road stud is installed without glue such as epoxy resin containing carcinogen.

Further, the present invention provides a road stud which is installed anytime regardless of restriction conditions such as the relative humidity of air and the dryness of a road surface.

Although the preferred embodiments of the present invention have been disclosed for illustrative purpose, those skilled in the art will appreciate that various modifications, additions and substitutions are possible, without departing from the scope and spirit of the invention as disclosed in the accompanying claims.

What is claimed is:

1. A road stud comprising:
an indicating part exposed on a road surface;
an anchor extended from the bottom of the indicating part and inserted into an anchor inserting hole provided under the road surface; and
a rotation preventing projection radially protruded from a central axis of the anchor and preventing the indicating part from being rotated.

2. The road stud according to claim 1, further comprising a reinforcing plate formed with an anchor through hole through which the anchor is fitted, and the rotation preventing projection is provided on the reinforcing plate.

3. The road stud according to claim 2, wherein the rotation preventing projection is formed by cutting and bending a part of the reinforcing plate.

4. The road stud according to claim 3, wherein the rotation preventing projection has a round edge.

5. The road stud according to claim 2, wherein the anchor through hole is formed with a predetermined cut-off lines.

6. The road stud according to claim 2, wherein the reinforcing plate is combined to the bottom of the indicating part by welding.

7. The road stud according to claim 1, wherein the rotation preventing projection is provided in the indicating part.

8. The road stud according to claim 1, further comprising a locking member combined to the anchor, having a holding projection radially provided to the central axis of the anchor and elastically contacting and supporting the inside wall of the anchor inserting hole so as to prevent the anchor from breaking away from the anchor inserting hole.

9. The road stud according to claim 8, wherein the locking member includes a combination part to be combined to the anchor, and a plurality of elastic holding parts extended from the combination part, being arranged around the anchor, and elastically holding the anchor in the anchor inserting hole.

10. The road stud according to claim 9, wherein the holding projection is formed on a free end of the elastic holding part.

11. The road stud according to claim 9, wherein at least one of the elastic holding parts is formed in a pair.

12. The road stud according to claim 9, wherein the combination part of the locking member includes a hole to which the anchor is fitted.

13. The road stud according to claim 12, wherein on the hole is formed with a cut-off line with a predetermined length

14. The road stud according to claim 8, further comprising a breakaway preventing washer having a through hole to which the anchor is inserted, and combined to the outside of the locking member fitted to the anchor in order to prevent the locking member from breaking away from the anchor.

15. The road stud according to claim 8, further comprising a sink-preventing projection provided in the locking member and preventing the anchor inserted in the anchor inserting hole from sinking down.

16. The road stud according to claim 8, wherein the anchor is formed with a stepped end part.

17. The road stud according to claim 9, wherein the rotation preventing projection is provided in the elastic holding part.

18. The road stud according to claim 17, wherein the rotation preventing projections are extended from the opposite edges of the elastic holding part, transversely to a lengthwise direction of the elastic holding part.
